(19) United States
(12) Patent Application Publication
(10) Pub. No.: US 2012/0266734 A1
(43) Pub. Date: Oct. 25, 2012

(54) Guitar neck

(76) Inventor: Robert M. Kunstadt, New York, NY (US)

(21) Appl. No.: 13/066,584

(22) Filed: Apr. 19, 2011

(51) Int. Cl. G10D 3/00

(52) U.S. Cl. 84/293

(57) ABSTRACT

A guitar neck made as a unitary part, including its frets and nut, is provided with a coating of sufficient hardness to resist string wear. Slots arrayed longitudinally along the back of the neck permit the neck to be light in weight, while being made of a material rigid enough to resist warping from string tension. Due to this integral configuration, the neck does not require a trussrod.

### FIELD OF THE INVENTION

This invention relates to the field of necks for stringed musical instruments known as guitars, including bass guitars.

### SUMMARY OF THE INVENTION

In the present invention, the neck may be made as a unitary part, including its frets and nut. The neck may be provided with a coating of sufficient hardness to resist string wear. Slots arrayed longitudinally along the back of the neck permit the neck to be light in weight, while being made of a material rigid enough to resist warping from string tension without requiring a trussrod.

### DESCRIPTION OF THE DRAWINGS

FIG. 1 is a bottom plan view of a guitar neck according to the invention.

FIG. 2 is a right side view of a guitar neck according to the invention.

FIG. 3 is a left side view of a guitar neck according to the invention.

FIG. 4 is a top plan view of a guitar neck according to the invention.

FIG. 5 is a perspective view of a guitar neck according to the invention.

FIG. 6 is an end view from the heel of a guitar neck according to the invention.

FIG. 7 is an end view from the headstock of a guitar neck according to the invention.

### DETAILED DESCRIPTION OF THE INVENTION

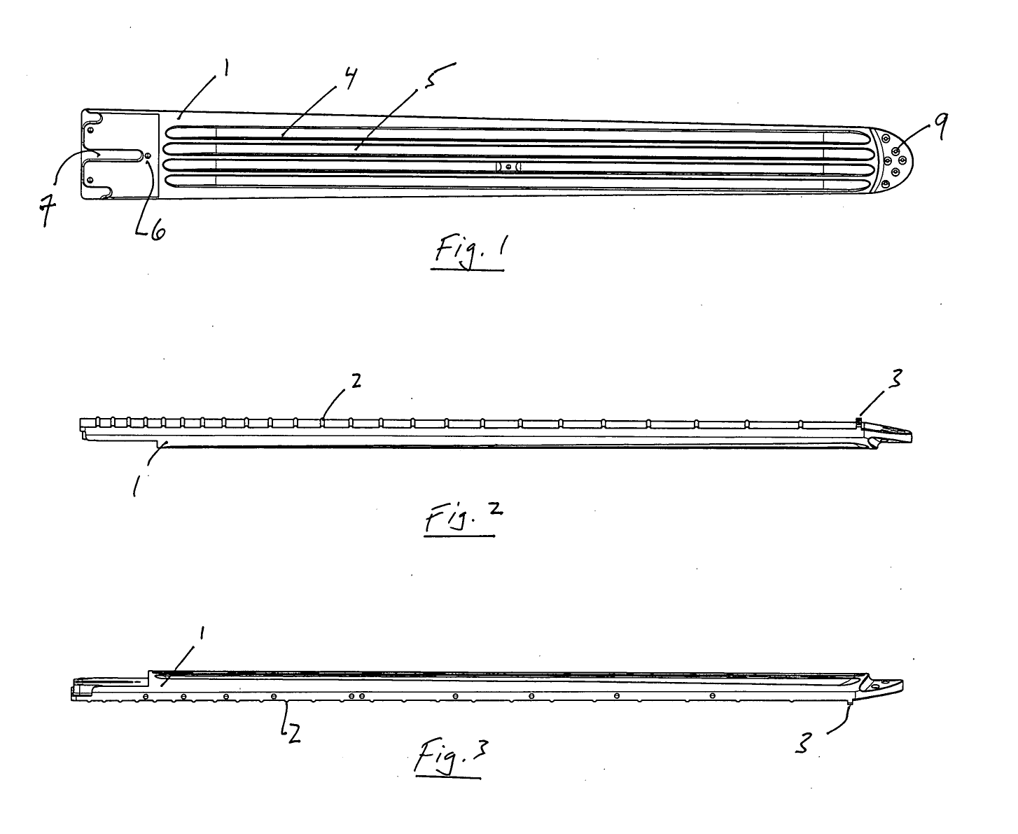

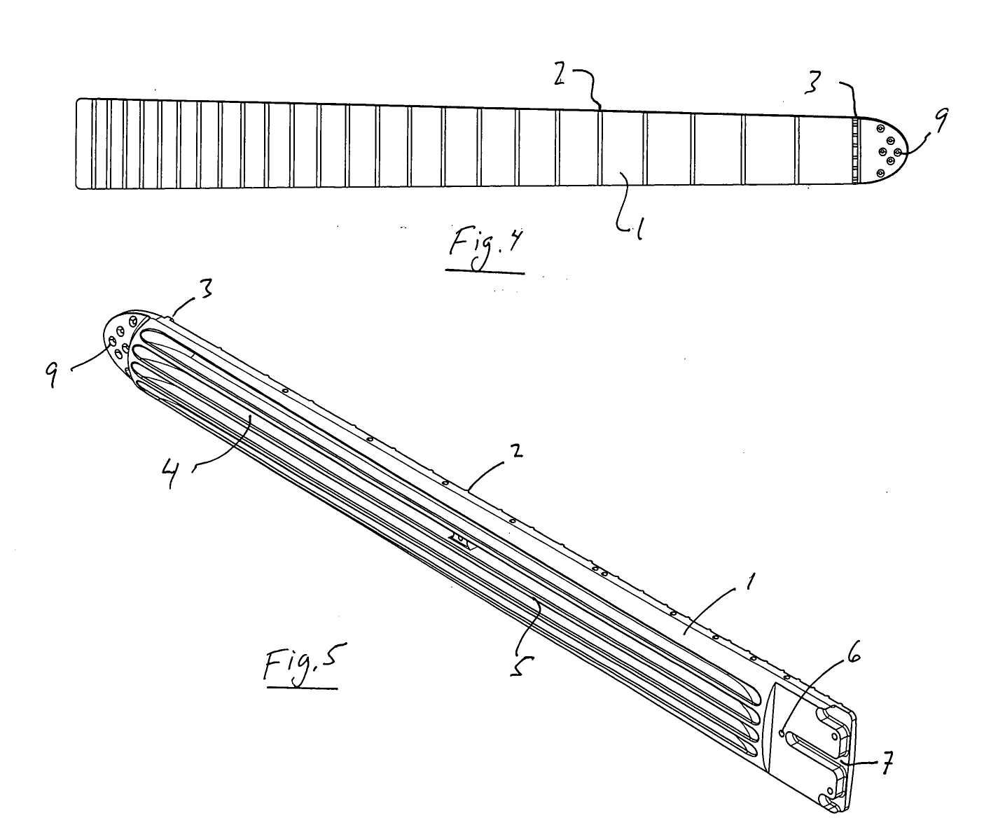

Referring now to FIGS. 1-7, the invention will be described in detail.

Referring now to FIGS. 1-2, neck 1 comprises frets 2, and nut 3. Along the bottom surface of the displayed neck (which corresponds to the “back” of the neck in guitarists' conventional parlance) are provided longitudinally-arrayed slots 4 (see the bottom view, FIG. 1), which lighten the neck. Between slots 4 are ridges 5, which not only define the curvature of the surface of neck 1, but also act as resonant members which enhance the tone produced by neck 1 when the instrument's strings are fingered and plucked.

Provided slots 4 are not so wide that the player's thumb gets caught in them, a guitar neck is playable even with openings such as slots 4. The width of slots 4 may be about 0.25 inches each; the length about 17.5 inches (for a guitar neck of so-called “Fender scale” (25.5 inches)); and the depth about 0.4 inches. In a preferred embodiment, four such slots may be provided; and the slots may be arrayed so the highest of ridges 5, is positioned generally along the centerline of neck 1.

The resulting arrangement of slots 4 and ridges 5 is particularly advantageous in that the surface of neck 1 is not so sticky in feel as a conventional neck with its typical continuous surface-coating of a sprayed-on wood finish. Nor does it tend so much to become slippery from sweat buildup from the player's hand, since slots 4 permit some cooling air to circulate. Indeed, the texture provided by slots 4 and ridges 5 promotes good musicianship, since it reminds the player not to grip the guitar neck as if holding on for dear life (a common beginner error). A relaxed grip on the neck promotes good tone and fast fingering; and prevents the player's hand from tiring too quickly. The combination of low action due to the accuracy of layout of frets 2 on neck 1, together with the texture of slots 4 and ridges 5 on neck 1, and the non-sticky feel of the anodizing applied to neck 1, provides a beneficial total neck system that is particularly advantageous to the guitar player.

Neck 1 may be made of aluminum. Alloys include the commonly-available 6061; or MIC-6 (which is a cast alloy and hence said to be relatively stable when machined). Neck 1 may alternatively be cast rather than machined. Alternative materials may include others with similar properties as aluminum. Note that whether machined or cast, neck 1 forms an integral unit. It is not necessary to provide a fretboard, frets or nut as separate add-ons to the neck, as is done in conventional practice.

The integral nature of the assembly permits good tone and sustain to be achieved, by eliminating air gaps between parts that interfere with vibration transmission between the various parts due to discontinuities of material affecting the speed of sound, the need to use glue or other fastening means and the like. The fact that all parts, including the fretboard, frets and nut may be manufactured in one precision operation, insures that good accuracy of intonation is achieved; and that the fret heights are uniformly level, which permits attainment of good “action” of the neck (ease of fingering the strings on the frets) by permitting the strings' rest height to be set at the guitar's bridge to approach the frets closely without “buzzing” on them (which happens if a fret is higher or lower than its adjacent frets).

Moreover, since frets 2 are integral to neck 1, there is no need to provide slots in the fingerboard of neck 1 for receiving the mounting tangs of conventional fretwire. Such slots are disadvantageous since they substantially reduce the strength of a conventional neck, because they interrupt its top surface at precisely the location where substantial compressive force is exerted by the tuned, tensioned guitar strings. Hence, a neck with integral frets according to the invention is particularly well-suited to withstand the warping forces resulting from string tension. No trussrod or other supplemental mechanical arrangement is required for that purpose. Since a trussrod can be dispensed with, manufacture is simplified. Moreover, since a trussrod can be a source of spurious resonances, even rattling if maladjusted, it is advantageous to be able to make a guitar neck without a trussrod—as the neck is consequently tonally superior.

So that neck 1 and its integral parts may resist string wear, especially wear on frets 2, the entire assembly may be made from aluminum and may preferably be hard-anodized, also known as military or mil-spec anodized (the three terms are used as synonyms herein, consistent with the following defined properties).

This is not simply color-anodizing for decorative purposes, but rather it is anodizing with a coating-material of sufficient hardness and thickness that string wear of frets 2 is substantially prevented. In case of doubt, mere decorative anodizing that is unsatisfactory for use in the invention can be detected by rubbing a wound electric-guitar string (such as a low E string) across an anodized test-surface having the curvature typical of a fret. Removal of the unsatisfactory coating can be detected with the naked eye using this test—since the string windings act as a file to remove the unsatisfactory coating and expose bare aluminum. But when this test is applied to a coating-material suitable for use in the invention, bare aluminum does not become visible.

It is not to be excluded that in future, hard-anodizing with the necessary properties may be brightly-colored (due to improvements in anodizing processes); but at present, a color of hard-anodizing of the type suitable for use in the invention, has been found to be dark greenish-brown.

The anodizing may cover the entire assembly of neck 1, or the assembly may be masked so that only frets 2, or only frets 2 and nut 3, are so anodized. In any event it is preferred that some portion of neck 1, such as mounting-screw holes 6, be masked from anodizing in order to provide an electrical connection from neck 1 to the rest of the guitar (in order to ground neck 1).

Alternatively, neck 1 and its integral parts may be chrome-plated or nickel-plated; or supplied with another coating-material (now known or later developed) of sufficient hardness and thickness that string wear of the frets 2 is substantially prevented.

The heel of neck 1 may advantageously be provided with recess 7, which is formed to receive a projecting ridge that may be provided on the mating mounting-pocket of a guitar body. The interlocking so facilitated, enhances the rigidity of connection of neck 1 to a guitar body, since the mating mounting-pocket provided on the guitar body may thereby be strengthened by inclusion of a projecting ridge on such mounting-pocket, with such ridge being formed so as to mate with recess 7.

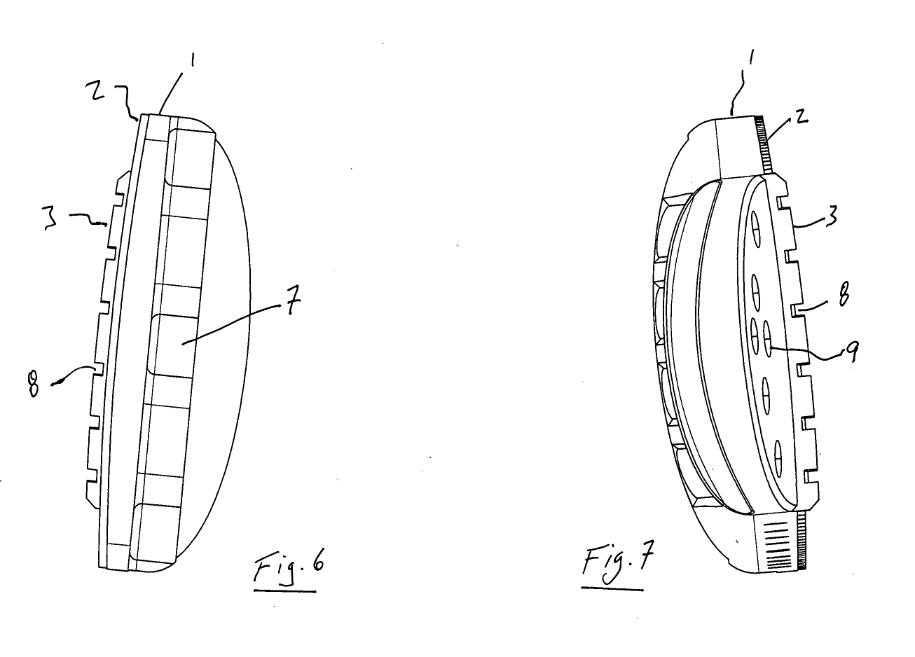

Referring to FIGS. 6-7, nut 3 is provided with slots 8 for receiving strings. The strings may be anchored by their ball-ends in holes 9 in neck 1. Unlike conventional nut slots, slots 8 may be formed substantially wider than the diameter of the strings they receive, since the strings are each angled towards the centerline of neck 1 (towards their respective holes 9), as well as being angled downwards, as they pass through slots 8. By means of such angling of the strings towards the centerline of neck 1 (with the strings being angled at about 10 degrees; and hence with each of slots 8 being angled at about half that amount, or about 5 degrees), the strings touch slots 8 only on one side thereof, not on both sides (as is conventional) (as well as on the bottom of each of slots 8). This arrangement permits slots 8 to be substantially wider than conventional nut slots, which facilitates their machining (or casting) from the single piece of material comprising neck 1. For example, if machined, slots 8 can be cut with a tool of relatively-wide diameter (such as about 1/16″ in the case of a guitar neck), which is advantageously resistant to breakage compared to a tool having about the width of a string (typically 0.010″-0.046″ for guitar strings).

By utilizing the expedients shown and described, it would be possible to mass-produce finished guitar necks, ready to play, that are light in weight; comfortable to hold; resistant to warping and string wear; uniformly and consistently well-intonated; with low action; and easy for both experts and beginners to play well. Due to the resonant properties of such integral necks, they would provide superior tonal quality including long sustain; even response at all fret positions; and singing high overtones optimized to “cut through the mix” in live band performances and on recordings.

The invention is not limited to the exact embodiments shown and described, and may be realized in such other ways as will be apparent to the skilled artisan, utilizing the teachings of the invention.

1. A guitar neck comprising:
a. a fingerboard;
b. a nut;
c. a mounting region;
d. string anchors;
e. a back; and
f. a plurality of longitudinal slots along substantially the length of said back.

2. A neck according to claim 1, said neck being made substantially from aluminum.

3. A neck according to claim 1, the number of said slots being at least two.

4. A neck according to claim 2, the number of said slots being four.

5. A neck according to claim 4, two of said slots defining a ridge along the centerline of said neck.

6. A neck according to claim 5, said neck being machined from a single billet of aluminum.

7. A neck according to claim 5, said neck being provided with a coating resistant to string wear.

8. A neck according to claim 7, said coating being hard anodizing.

9. A neck according to claim 5, said neck being cast aluminum.

10. A neck according to claim 1, said mounting region being a shoulder at the heel of said neck, said shoulder being provided with a recess along the centerline of said neck.

11. A neck according to claim 1, said nut being provided with a plurality of string slots, each of said plurality of string slots being angled inwards towards its respective one of said string anchors and towards the centerline of said neck.

12. A neck according to claim 11, each of said plurality of string slots being at least 0.060″ wide.

13. A neck according to claim 11, each of said plurality of string slots being angled about five degrees.

14. A neck according to claim 12, each of said plurality of string slots being angled about five degrees.
